(19) United States
(12) Patent Application Publication
(10) Pub. No.: US 2004/0062190 A1
(43) Pub. Date: Apr. 1, 2004

(54) Disk cartridge

(75) Inventor: Fumihito Imai, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/671,788

(22) Filed: Sep. 29, 2003

(30) Foreign Application Priority Data
Sep. 30, 2002 (JP) 287634/2002

(51) Int. Cl. G11B 7/26

(52) U.S. Cl. 369/291

(57) ABSTRACT

A frame and upper and lower shells made of metal plates covering the top and bottom of the frame constitute a flat housing. A disk cartridge rotatably houses a disk serving as a recording medium in the flat housing. Disassembly of the disk cartridge is facilitated. An engaging protrusion 25 is provided on at least one of the side of the frame 22. The engaging protrusion can freely oscillate in and out from the surface and is elastically urged in a direction the engaging protrusion 25 protrudes from the surface. At the same time, an engaging aperture 23c which engages with the engaging protrusion 25 is formed on at least one of the upper and lower shells 23 and 24.

### BACKGROUND OF THE INVENTION

1. Field of the Invention

The present invention relates to a small disk cartridge which rotatably houses a disk serving as a recording medium in a flat housing constituted of a frame and upper and lower shells made of metal plates covering the top and bottom of the frame. More particularly, the present invention relates to an assembly structure of the housing.

2. Description of the Related Art

Recording media, e.g., a micro-magnetic disk cartridge called “clik!” (registered trademark) shown in a schematic perspective view in FIG. 9, have conventionally been used for mobile equipment such as digital cameras.

FIGS. 10A to C are a plan view, a right side view, and a bottom plan view of a closed rotary shutter 7 of a magnetic disk cartridge 1, respectively. FIGS. 11A and B are a plan view and a bottom plan view of the opened rotary shutter 7, respectively. FIG. 12 is an exploded perspective view of the magnetic disk cartridge 1. As shown in these drawings, a flat housing of the magnetic disk cartridge 1 rotatably contains a magnetic disk 5. A resin frame 2 and upper and lower shells 3 and 4 constitute the housing. The resin frame 2 includes a pressing portion 2a, and the upper and lower shells 3 and 4 are made of thin metal plates. The dimensions of the housing are 50 mm wide by 55 mm deep by 1.95 mm thick. The magnetic disk 5 has a storage capacity of 40 MB and a diameter of 1.8 inches (45.7 mm).

The magnetic disk cartridge 1 is provided with a V-shaped opening 6 and a rotary shutter 7. The opening 6 is for a magnetic head provided in a disk drive, into which the cartridge 1 is inserted to be mounted, to access the surface of the magnetic disk 5, and the rotary shutter 7 opens and closes the opening 6. Upper and lower shutter members 7U and 7D (refer to FIG. 12) engage each other to form the rotary shutter 7, and a center pin 17 axially supports the upper shutter member 7U beneath the upper shell 3. Liners 18 are individually inserted between the magnetic disk 5 and the upper shutter member 7U and between the magnetic disk 5 and the lower shutter member 7D.

In addition, a notch 8 is formed in the top portion on the left side of the housing in FIG. 10A, and a small window 9 is formed in the top portion of the right side. The notch 8 engages with an engaging member of the disk drive to ensure the positioning of the magnetic disk cartridge 1 in the disk drive. The small window 9 is for a shutter locking member 11, which locks the rotary shutter 7 at a closed position, to face the exterior.

A circular opening 4a and an arcuate groove 4b are formed on the lower shell 4 of the housing. The opening 4a is for a center core 10 of the magnetic disk 5 to connect with a drive spindle of the disk drive, and the arcuate groove 4b is concentric with the rotary shutter 7. A shutter knob 7b is fixed to the lower shutter 7d. The shutter knob 7b protrudes from the arcuate groove 4b and moves along the arcuate groove 4b to open and close the rotary shutter 7.

FIGS. 13A and B are plan views of the rotary shutter 7 in its closed and opened state, respectively, shown by removing the upper shell 3 and omitting the magnetic disk 5.

The shutter locking member 11 is provided with an engaging protrusion 11a at the tip thereof. The protrusion 11a can engage with an engaging recess 7c formed on the periphery of the rotary shutter 7, and the shutter locking member 11 locks the rotary shutter 7 at the closed position. The shutter locking member 11 is rotatably attached to a shaft 12 provided in the housing, and a spring plate 11b urges the shutter locking member 11 in the direction (counterclockwise direction in FIG. 13) that enables the engaging protrusion 11a to engage with the engaging recess 7c. When the magnetic disk cartridge 1 is inserted into the disk drive, a lock releasing member provided in the disk drive passes through the small window 9 to press the shutter locking member 11. Accordingly, the locking member 11 is slightly rotated clockwise, and the engaging protrusion 11a escapes from the engaging recess 7c. Thus, the lock on the rotary shutter 7 is released.

A long thin coil spring 14 with a small diameter urges the rotary shutter 7 in a closing direction (counterclockwise direction in FIG. 13). A guide wire 13 is provided to mount the coil spring 14 thereto. One end of the guide wire 13 is latched to the frame 2 at a portion 2b which faces the periphery of the rotary shutter 7, and the other end slidably penetrates a support member 7d fixed to the periphery of the rotary shutter and extends along the periphery of the rotary shutter 7. As shown in FIG. 13A, the coil spring 14 is compressed and provided between the portion 2b of the frame 2 and the support member 7d so as to be compressed and expanded along the guide wire 13. The coil spring 14 urges the rotary shutter 7 in the closing direction (counterclockwise direction in FIG. 13). When the rotary shutter 7 which has been released from the lock is rotated from this state in a clockwise direction in FIG. 13, the coil spring 14 becomes compressed as shown in FIG. 13B.

Incidentally, when assembling the foregoing conventional magnetic disk cartridge 1, the upper and lower shells 3 and 4 cover the frame 2 from the top and bottom thereof, and edges of the upper and lower shells 3 and 4 abut each other. Thereafter, as shown in FIG. 9, ten or more spots P are laser welded to assemble the disk cartridge 1. Hence, it takes considerable time and energy to disassemble the disk cartridge 1 for recycling and waste separation and disposal since the welds must be broken.

### SUMMARY OF THE INVENTION

In consideration of the foregoing circumstances, an object of the present invention is to provide this type of disk cartridge, which is capable of being disassembled without breaking welds.

The disk cartridge rotatably houses a disk, which is a recording medium, in a flat housing. The flat housing is constituted of a frame and upper and lower shells made of metal plates covering the top and bottom of the frame.

The present invention is characterized in that an engaging protrusion is provided on at least one of upper and lower surfaces of the frame and an engaging aperture which engages with the engaging protrusion is formed on at least one of the upper and lower shells. The engaging protrusion can freely oscillate in and out from the surface and is elastically urged in the direction that the engaging protrusion protrudes from the surface.

The present invention is also characterized in that the frame, in which the engaging protrusion is sunk from the surface, is inserted into a space formed between the upper and lower shells until the engaging protrusion is at a position to be aligned with the engaging aperture. Thus, the engaging protrusion engages with the engaging aperture, and the housing is assembled.

The engaging protrusion is preferably coupled to the frame via thin portions which have elasticity and are integrally formed with the engaging protrusion and the frame by synthetic resin. In this case, a material of the frame is preferably ABS resin which is excellent in elastic deformability or polyester elastomer resin such as Hytrel (registered trademark).

Alternatively, the engaging protrusion can be formed separately from the frame and coupled to the frame via thin portions which have elasticity and are integrally formed with the engaging protrusion.

According to the disk cartridge of the present invention, a space is formed between the upper and lower shells by engagement of the upper and lower shells through, for example, welding. The frame, in which the engaging protrusion is sunk from the surface by thrust pressure against the urging force, is inserted into the space until the position the engaging protrusion is aligned with the engaging aperture. Accordingly, the engaging protrusion engages with the engaging aperture by the urging force, thereby assembling the housing. Thus, upon disassembly, the engagement between the frame and the upper and lower shells can be released by simply pressing the engaging protrusion engaged with the engaging aperture against the urging force. Therefore, there is an advantage that the disk cartridge can be easily disassembled without breaking the welds.

Moreover, in the case where the engaging protrusion is coupled to the frame through the thin portions which have flexibility and are integrally formed with the engaging protrusion and the frame by synthetic resin, the engaging protrusion can obtain the urging force by the thin portions. Therefore, the structure of the disk cartridge becomes simple, facilitating the manufacture thereof.

### BRIEF DESCRIPTION OF THE DRAWINGS

FIG. 1 is a perspective view schematically showing a housing in an embodiment of a magnetic disk cartridge according to the present invention.

FIG. 2 is an exploded perspective view of the housing shown in FIG. 1.

FIG. 3A is an enlarged sectional view showing the essential part of a frame shown in FIG. 2, and FIGS. 3B and C are enlarged plan views showing the essential part of the frame shown in FIG. 2.

FIG. 4 is a perspective view showing a method of assembling the housing shown in FIG. 1.

FIG. 5 is an enlarged sectional view of the essential part of the housing.

FIGS. 6A to C are a plan view, a front view, and a plan view showing three modifications of the frame structures, respectively.

FIG. 7 is an exploded perspective view of a housing in another embodiment of a magnetic disk cartridge according to the present invention.

FIG. 8A is a sectional view showing a frame and an engaging member separate from the frame, and FIGS. 8B and C are a perspective view and a plan view showing the engaging member, respectively.

FIG. 9 is a perspective view showing a conventional magnetic disk cartridge.

FIGS. 10A to C are a plan view, a right side view and a bottom plan view showing the magnetic disk cartridge in FIG. 9 when a rotary shutter is closed, respectively.

FIGS. 11A and B are a plan view and a bottom plan view showing the magnetic disk cartridge in FIG. 9 when the rotary shutter is open, respectively.

FIG. 12 is an exploded perspective view showing the magnetic disk cartridge in FIG. 9.

FIGS. 13A and B are plan views showing a positional relationship between inner parts when the rotary shutter of the magnetic disk cartridge in FIG. 9 is closed and opened, respectively.

### DESCRIPTION OF THE PREFERRED EMBODIMENTS

Embodiments of the present invention are detailed below with reference to the drawings.

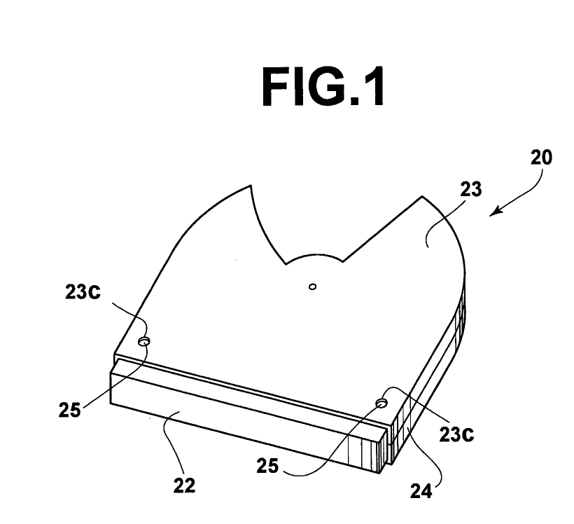

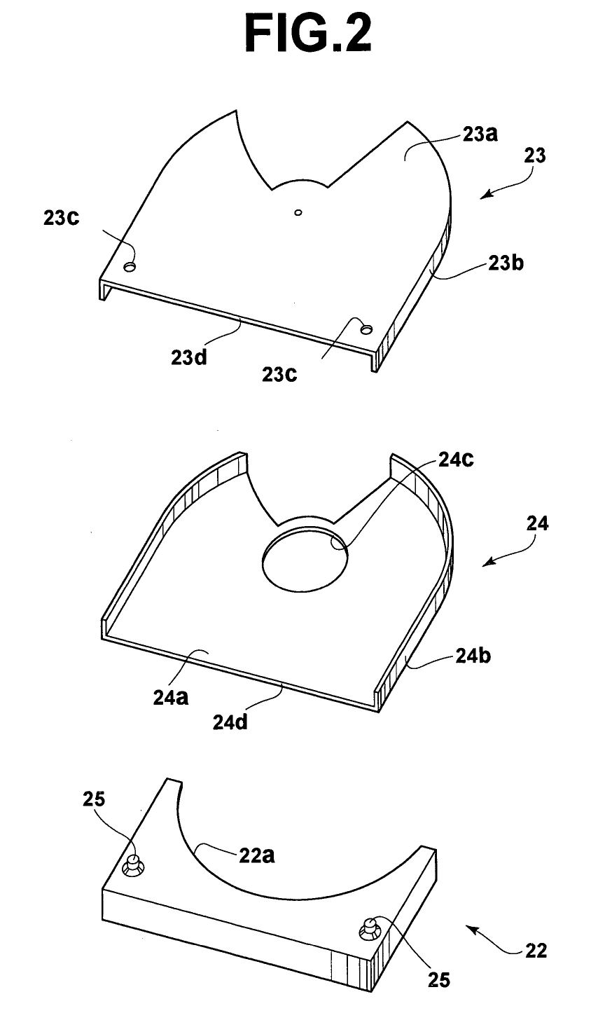

FIGS. 1 to 5 are views schematically showing a housing of a magnetic disk cartridge according to the present invention. FIG. 1 is a perspective view of the assembled magnetic disk cartridge, and FIG. 2 is an exploded perspective view of the magnetic disk cartridge. To facilitate understanding, the constituent parts are shown with dimensions having ratios different from the actual ratios, and details are omitted in FIGS. 1 to 5 to schematically show the magnetic disk cartridge.

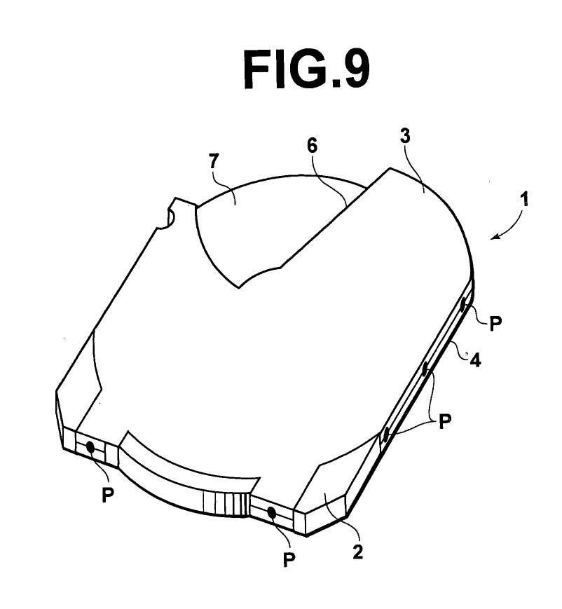

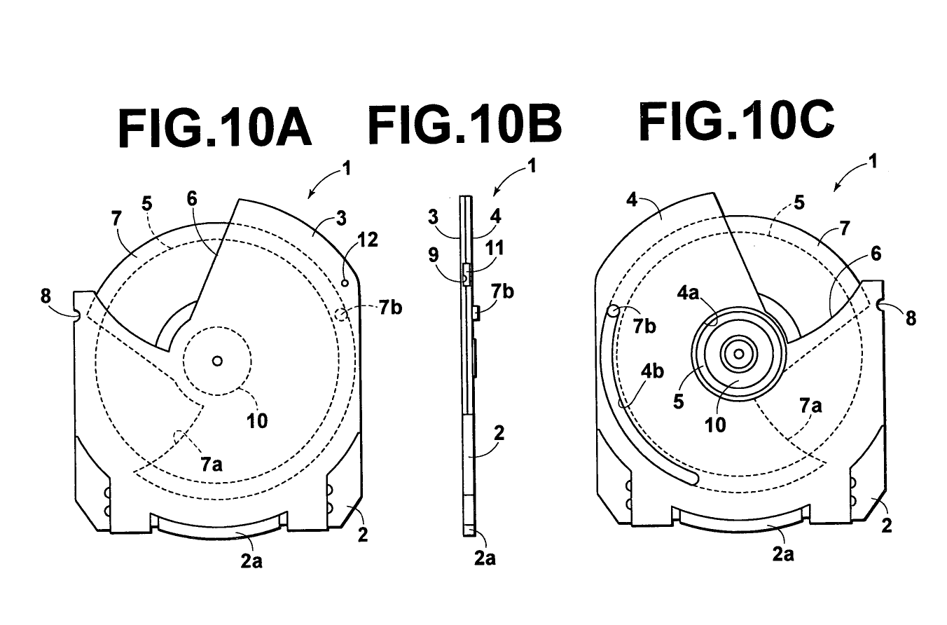

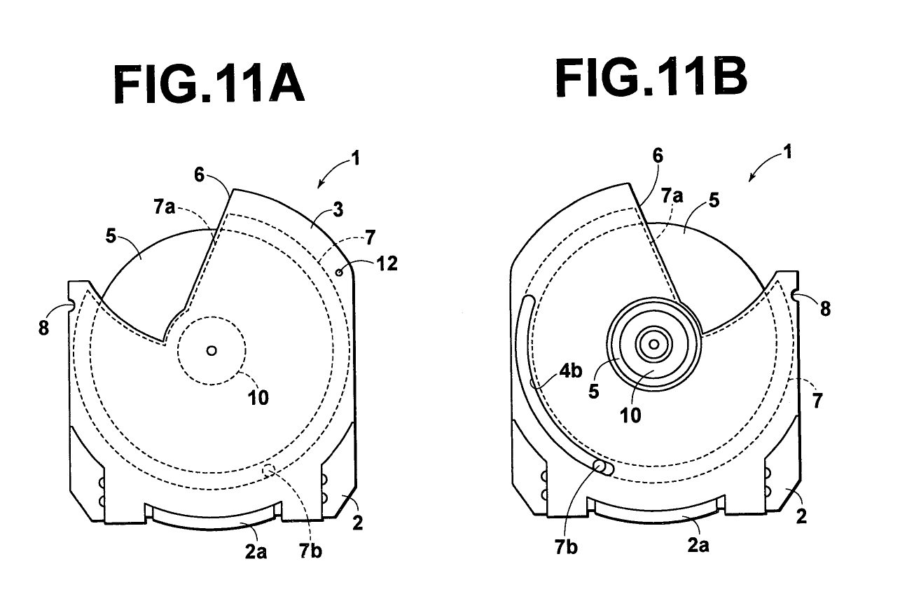

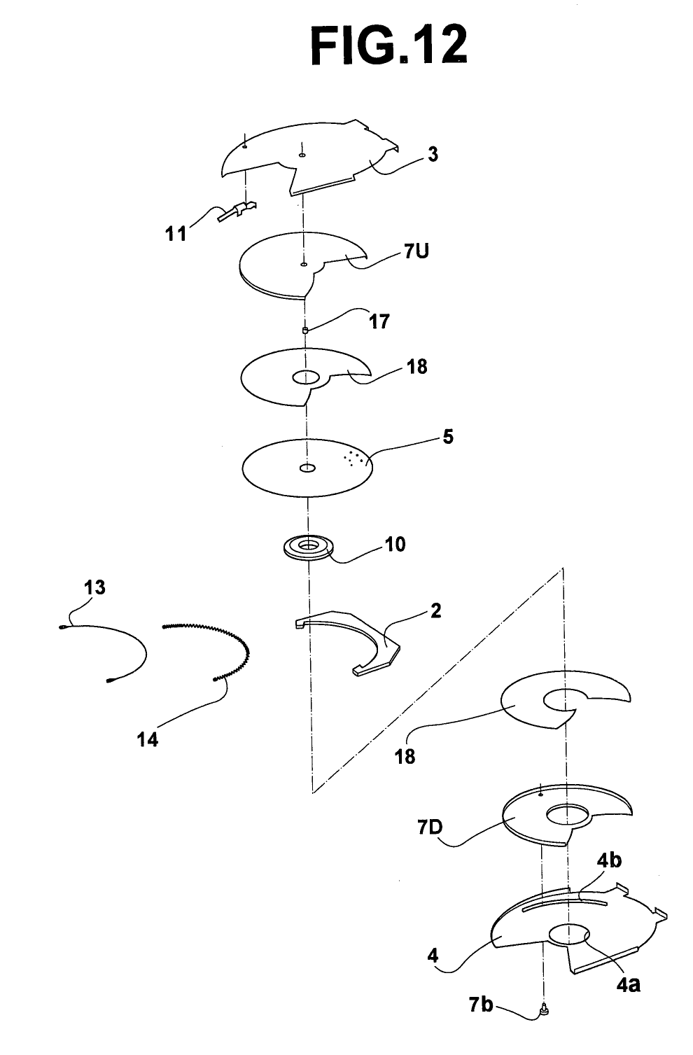

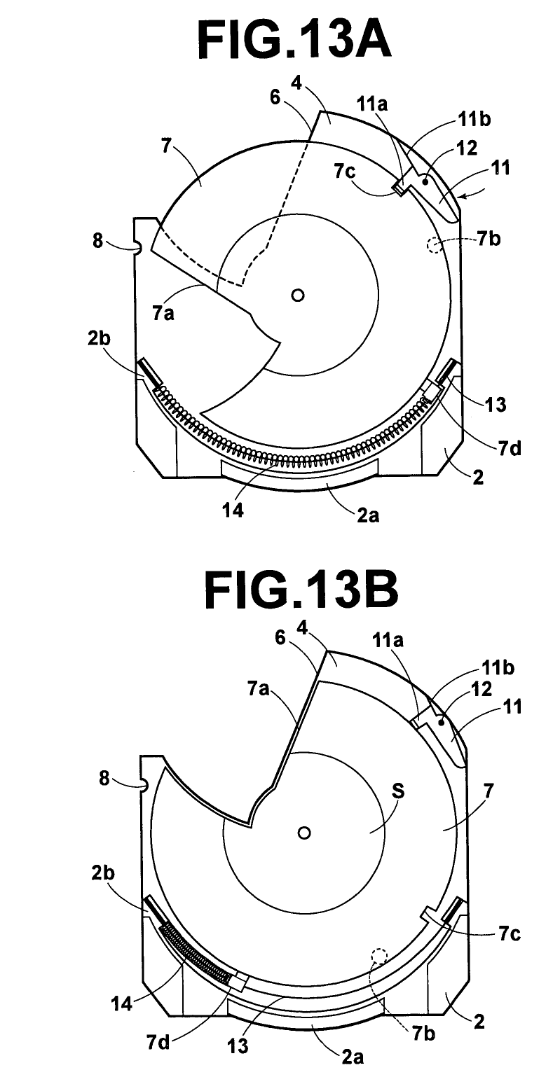

In FIGS. 1 and 2, a synthetic resin frame 22 and upper and lower shells 23 and 24 constitute the housing of the magnetic disk cartridge 20. The frame 22 is preferably made of ABS resin or polyester elastomer resin such as Hytrel (registered trademark) and the like, and the upper and lower shells 23 and 24 are made of 0.2 mm-thick stainless steel plates. Of the magnetic disk cartridge 20, only the structure of the housing differs from the conventional magnetic disk cartridge 1 shown in FIGS. 9 through 13. In other respects, the magnetic disk cartridge 20 has substantially the same parts contained in the housing as the conventional magnetic disk cartridge 1.

The upper shell 23 is formed of a flat part 23a and sidewalls 23b extending perpendicularly from the periphery of the flat part 23a, excluding a straight front edge 23d. Engaging apertures 23c and 23c are provided in the vicinity of the right and left ends of the front edge 23d. Engaging protrusions 25 of the frame 22, to be described later, engage with the engaging apertures 23c and 23c. The lower shell 24 is formed of a flat part 24a and sidewalls 24b. The flat part 24a has the same outer shape as that of the flat part 23a of the upper shell 23, and the sidewalls 24b extend upward from the outer edge of the flat part 24a, excluding a straight front edge 24d. At the center of the flat part 24a, a circular aperture 24c is formed for a center core 10 to face the exterior.

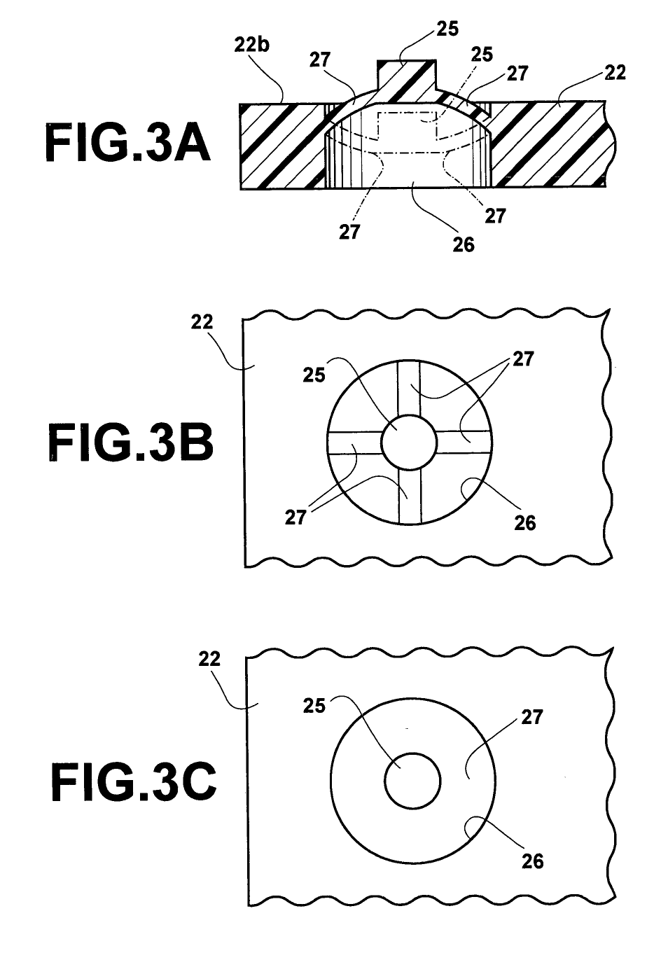

The frame 22 comprises an arcuate inner edge 22a as well as engaging protrusions 25 at the right-and-left ends of the upper surface. As shown in an enlarged sectional view in FIG. 3A and an enlarged plan view in FIG. 3B, the engaging protrusion 25 is supported by four thin portions 27 to protrude from an upper surface 22b of the frame 22. The four thin portions 27 extend from an inner wall of an aperture 26 toward the center of the aperture 26 as beams, and the aperture 26 penetrates the frame 22 from the top to the bottom. The engaging protrusions 25 and the thin portions 27 are integrally formed with the frame 22 by a synthetic resin material. The four thin portions 27 have elasticity. Thus, by depressing the upper surface of the engaging protrusion 25, the engaging portion 25 can be sunk from the upper surface 22b of the frame 22 as indicated by broken lines in FIG. 3A. This urges the engaging protrusion 25 in a direction so that the engaging protrusion protrudes from the upper surface 22b of the frame 22, in other words, in an upward direction. Note that the number of the thin portions 27 may be three, and the number of the beam-like thin portions is not particularly limited. Alternatively, the thin portion 27 may enclose the entire periphery of the engaging protrusion 25 as a diaphragm as shown in FIG. 3C.

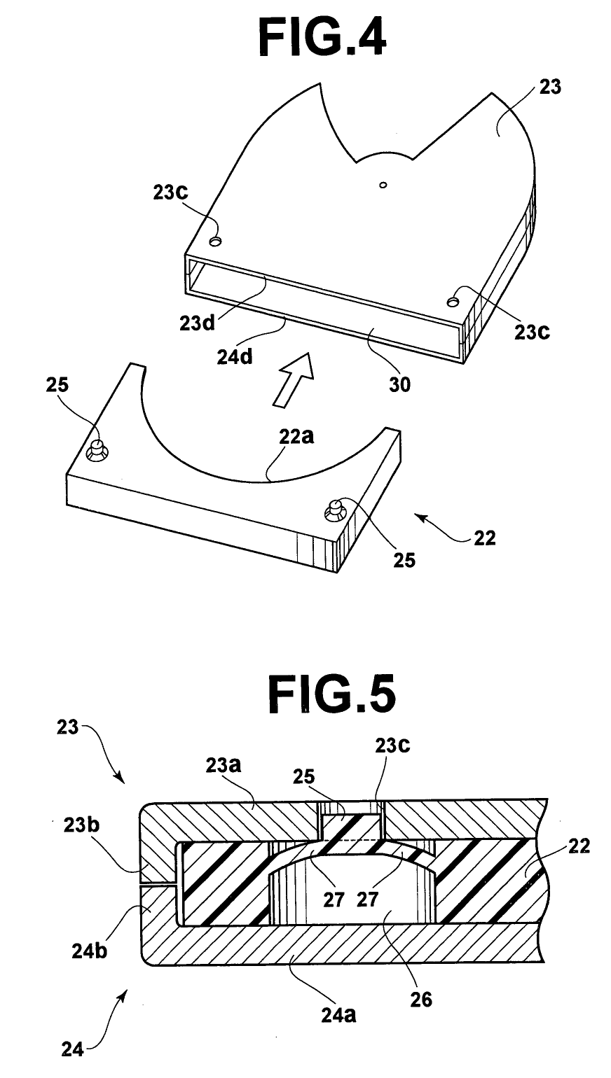

To assemble a housing by use of the frame 22 and the upper and lower shells 23 and 24 having these structures, first, side edges 23b and 24b of the upper and lower shells 23 and 24 are abutted and integrated by, for example, welding, to form a space having an opening 30 defined by straight front edges 23d and 24d, as shown in FIG. 4.

Next, the engaging protrusions 25 and 25 are depressed and sunk from the upper surface 22b of the frame 22 into the apertures 26 and 26, and the frame 22 is inserted into the space between the upper and lower shells 23 and 24 from the opening 30. At this time, the engaging protrusions 25 and 25 are abutted on the lower surface of the upper shell 23 and slide along the lower surface of the flat part 23a of the upper shell 23. When the frame 22 is inserted to the position at which the engaging protrusions 25 and 25 are aligned with the engaging apertures 23c and 23c of the upper shell 23, the thin portions 27 elastically urge the engaging protrusions 25 and 25 upward to engage with the engaging apertures 23c and 23c, respectively, as shown in FIG. 5. Accordingly, the frame 22 engages between the upper and lower shells 23 and 24. Thus, the assembly of the housing is completed. Note that it is not preferable for the engaging protrusion 25 to protrude from the surface of the upper shell 23 in the assembly shown in FIG. 5.

As apparent from the description, according to the present embodiment, the upper and lower shells 23 and 24 are integrated by, for example, welding, and a space is formed between the upper and lower shells 23 and 24. The frame 22, in which the engaging protrusions 25 and 25 are pressed and sunk from the upper surface, is inserted into the space to the position at which the engaging protrusions 25 and 25 elastically engage with the engaging apertures 23c and 23c. Accordingly, the housing is assembled. Thus, upon disassembly of the housing, the frame 22 can be pulled out from the space between the upper and lower shells 23 and 24 by simply pressing the engaging protrusions 25 and 25 engaged with the engaging apertures 23c and 23c to release the engagements between the engaging protrusions 25 and 25 and engaging apertures 23c and 23c. Therefore, a disk cartridge of the present invention has an advantage that the disk cartridge can be easily disassembled without breaking the welds.

Moreover, the engaging protrusions 25 and 25 are coupled to the frame 22 through the thin portions 27, which have elasticity and are integrally formed with the engaging protrusions 25 and 25 and the frame 22. Thus, the structure of the disk cartridge is simple and can be easily produced.

Upon disassembly, the engaging protrusions 25 and 25 may be depressed with strong force to break the thin portions 27. However, to recycle the parts, it is preferable to deform the thin portions 27 temporarily, instead of breaking them.

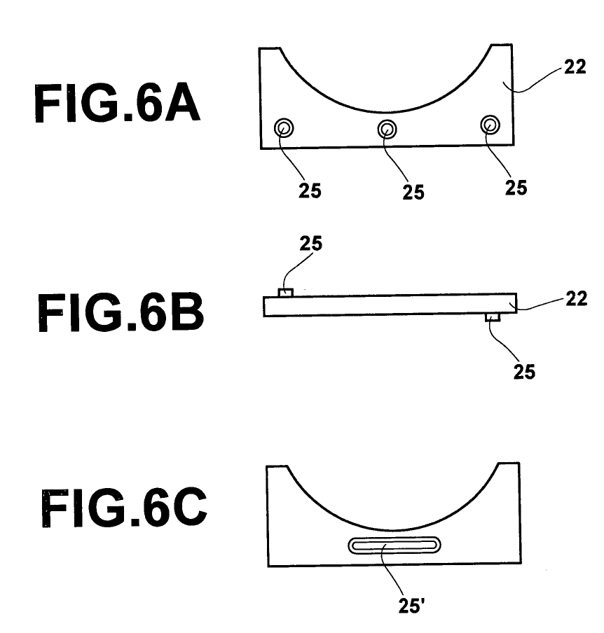

In the embodiment described above, two cylindrical engaging protrusions 25 and 25 are provided on the upper surface of the frame 22. However, as shown in FIG. 6A, three or more protrusions 25 may be provided. Moreover, as shown in FIG. 6B, the protrusions 25 can be provided on both upper and lower surfaces of the frame 22. In this case, the engaging apertures are provided on the flat part 24a of the lower shell 24 as well, at the positions corresponding to the engaging protrusions 25. Furthermore, the shape of the engaging protrusion is not limited to a cylinder. As shown in FIG. 6C, an engaging protrusion 25′ with an elongate shape when viewed from above maybe employed.

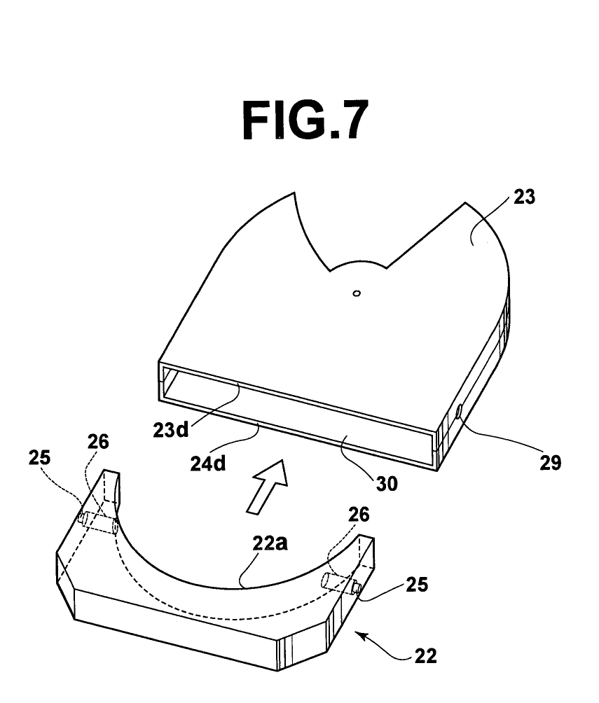

In addition, as shown in FIG. 7, the engaging protrusions 25 can be provided on both sides of the frame 22. In this case, the apertures 26 are provided horizontally in the frame 22, and engaging apertures 29 are provided on both sides of the upper and lower shells 23 and 24.

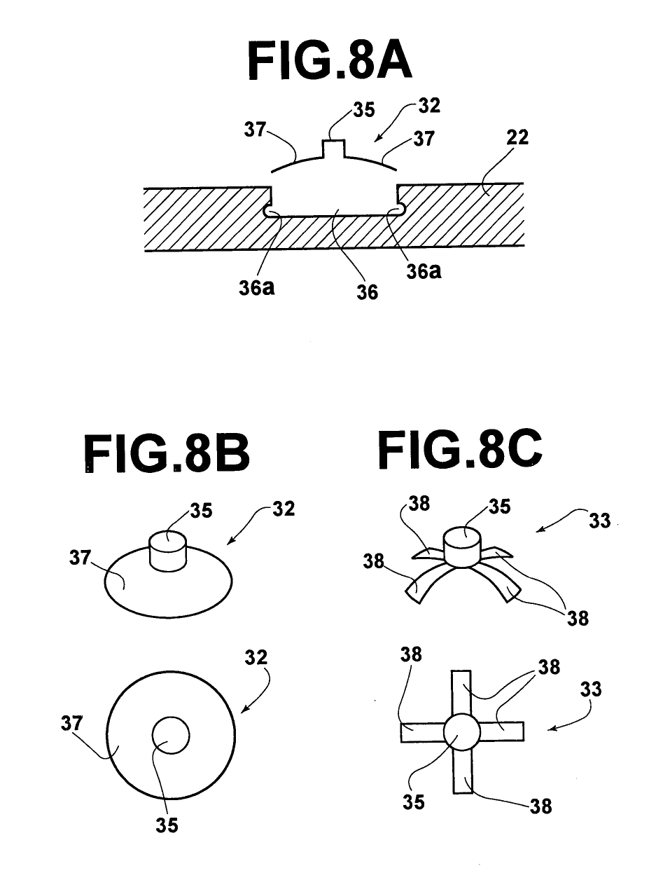

Furthermore, as shown in FIGS. 8A and B, an engaging member 32, separate from the frame 22, having an engaging protrusion 35 and a circular elastic thin portion 37 can be employed. In this case, a circular recess 36 is provided on the frame 22 to receive this engaging member 32, and grooves 36a are provided in the periphery of the bottom of the recess 36 to engage with the outer edge of the thin portion 37 to hold the engaging member 32. Although the engaging member 32 shown in perspective and plan views in FIG. 8B comprises a circular elastic thin portion 37, the engaging member 33 comprising quadrilateral thin portions 38 extending in four directions can be employed as shown in perspective and plan views in FIG. 8C.

Since the thin portion 37 of the engaging member 32 and the thin portions 38 of the engaging member 33 are required to be elastic, the engaging members 32 and 33 are preferably made by a wringing process from a PET sheet material or a PC (polycarbonate) sheet material when formed of resin. In the case that metal is employed as the material, the engaging members 32 are 33 are preferably made by wringing process from stainless steel plates.

What is claimed is:

1. A disk cartridge which rotatably houses a disk serving as a recording medium in a flat housing constituted of a frame and upper and lower shells made of metal plates covering a top and a bottom of the frame,
wherein an engaging protrusion is provided on at least one of either top or bottom side of the frame, and an engaging aperture which engages with the engaging protrusions is formed on at least one of the upper and lower shells, the engaging protrusion being able to freely oscillate in and out from the surface and being elastically urged in a direction in which the engaging protrusion protrudes from the surface, and
the housing is assembled by inserting the frame, in which the engaging protrusion is sunk from the surface, into a space formed between the upper and lower shells by engagement of the upper and lower shells to a position at which the engaging protrusion is aligned with the engaging aperture so that that the engaging protrusion engages with the engaging aperture.

2. The disk cartridge according to claim 1, wherein the engaging protrusion is coupled to the frame through a thin portion which has elasticity and is integrally formed with the engaging protrusion and the frame of synthetic resin.

3. The disk cartridge according to claim 1, wherein the engaging protrusion which is separately formed from the frame, is coupled to the frame through a thin portion having elasticity, and is integrally formed with the engaging protrusion.
